(19) United States
(12) Patent Application Publication
(10) Pub. No.: US 2025/0192944 A1
(43) Pub. Date: Jun. 12, 2025

(54) RESOURCE ALLOCATIONS FOR SYSTEM INFORMATION BROADCAST IN LOW POWER WIDE AREA COMMUNICATIONS

(71) Applicant: Lenovo (United States) Inc., Morrisville, NC (US)

(72) Inventors: Hossein BAGHERI, Dearborn Heights, MI (US); Vijay Nangia, Woodridge, IL (US); Karthikeyan Ganesan, Nauheim (DE)

(21) Appl. No.: 19/054,440

(22) Filed: Feb. 14, 2025

(51) Int. Cl. H04L 5/00

(52) U.S. Cl. CPC H04L 5/0048; H04L 5/0053

(57) ABSTRACT

Various aspects of the present disclosure relate to the transmission of system information for low power wide area (LPWA) devices using pre-determined resources that are based on aspects of a synchronization signal block (SSB) transmission (e.g., resource blocks (RBs) for the SSB) and/or a control resource set zero (CORESET0) configuration for non-LWPA devices. Further, the techniques can mitigate or avoid the overlap of monitoring occasions associated with use of the CORESET0 for both non-LWPA devices and LWPA devices. In doing so, the wireless communications system may reduce overhead introduced by the number of scheduling command transmissions for LPWA devices, among other benefits.

### TECHNICAL FIELD

The present disclosure relates to wireless communications, and more specifically to resource allocations for system information broadcast (SIB) in low power wide area (LPWA) communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

The wireless communications system may support LPWA communications, such as wireless communications for Internet of Things (IoT) devices. For example, IoT devices configured for LPWA communications may have constraints related to bandwidth, antenna capabilities, and/or other limitations. Unlike non-LPWA devices, such as enhanced mobile broadband (eMBB) devices, LPWA devices may include sensors, inventory tracking devices, and other feature-limited IoT devices.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support resource allocations for SIB in LPWA communications.

A UE for wireless communication is described. The UE may be configured to, capable of, or operable to perform one or more operations as described herein. For example, the UE may comprise at least one memory and at least one processor coupled with the at least one memory and configured to cause the UE to receive a synchronization signal block (SSB) that includes one or more synchronization signals and a physical broadcast channel (PBCH), determine a set of resources for reception of a system information block type 1 (SIB1) based at least in part on one or more resource blocks (RBs) associated with the SSB, an SSB transmission pattern, and information received via the PBCH, and receive the SIB1 via the determined set of resources.

A processor for wireless communication is described. The processor may be configured to, capable of, or operable to perform one or more operations as described herein. For example, the UE may comprise at least one controller and at least one memory coupled with the at least one controller and configured to cause the processor to receive a SSB that includes one or more synchronization signals and a PBCH, determine a set of resources for reception of an SIB1 based at least in part on one or more RBs associated with the SSB, an SSB transmission pattern, and information received via the PBCH, and receive the SIB1 via the determined set of resources.

A method performed or performable by the UE is described. The method may comprise receiving a SSB that includes one or more synchronization signals and a PBCH, determining a set of resources for reception of an SIB1 based at least in part on one or more RBs associated with the SSB, an SSB transmission pattern, and information received via the PBCH, and receiving the SIB1 via the determined set of resources.

In some implementations of the UE, processor, and method described herein, the UE, processor, and method, in response to the SIB1 being a SIB1 bandwidth reduced (SIB1-BR), may further be configured to, capable of, performed, performable, or operable to determine the set of resources based at least in part on a candidate set of resources, wherein the candidate set of resources comprises a set of frequency resources comprising one or more narrowbands, and wherein an indexing of the one or more narrowbands is according to a start of the SSB or an end of the SSB, or an offset based on the start of the SSB or the end of the SSB.

In some implementations of the UE, processor, and method described herein, the UE, processor, and method may further be configured to, capable of, performed, performable, or operable to identify a number of narrowbands based at least in part on the information received via the PBCH, wherein the set of resources is determined based at least in part on the identified number of narrowbands.

In some implementations of the UE, processor, and method described herein, the number of narrowbands is further based at least in part on a number of RBs of each narrowband and a number of RBs of a control resource set zero (CORESET0).

In some implementations of the UE, processor, and method described herein, the indexing of the one or more narrowbands is further according to a distance in a frequency domain between each narrowband and a first RB or a last RB of the SSB.

In some implementations of the UE, processor, and method described herein, the UE, processor, and method, where the set of resources comprises a set of time resources, may further be configured to, capable of, performed, performable, or operable to determine the set of time resources based at least in part on one or more of: a cell identifier associated with transmission of the SSB, a number of repetitions of SIB1, a portion of a frame associated with transmission of the SSB, or a SSB transmission pattern associated with a carrier frequency.

In some implementations of the UE, processor, and method described herein, a number of repetitions of SIB1 during a first portion of a radio frame is less than a number of repetitions of SIB1 during a second portion of the radio frame, and wherein the first portion of the radio frame is associated with transmission of the SSB.

In some implementations of the UE, processor, and method described herein, the UE, processor, and method, where the set of resources comprises a set of time resources, may further be configured to, capable of, performed, performable, or operable to determine the set of time resources based at least in part on a portion of a frame associated with transmission of the SSB or a SSB transmission pattern associated with a carrier frequency when a number of repetitions of SIB1 is greater than a threshold.

In some implementations of the UE, processor, and method described herein, the information received via the PBCH indicates at least two RB offsets, wherein a first RB offset of the at least two RB offsets spans between a first RB of the SSB to a first RB of the SIB1, and wherein a second RB offset of the at least two RB offsets spans between an end RB of the SIB1 to a first RB of a CORESET0.

In some implementations of the UE, processor, and method described herein, the information received via the PBCH indicates whether to skip resources associated with a CORESET0 for reception of the SIB1.

In some implementations of the UE, processor, and method described herein, the UE, processor, and method, where the set of resources comprises a set of time resources, may further be configured to, capable of, performed, performable, or operable to transmit a random access channel (RACH) message associated with the SSB.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit an SSB that includes one or more synchronization signals and a PBCH, wherein a set of resources for transmission of a SIB1 is based at least in part on one or more RBs associated with the SSB, an SSB transmission pattern, and information transmitted via the PBCH, and transmit the SIB1 via the set of resources.

A method performed or performable by the network entity is described. The method may comprise transmitting an SSB that includes one or more synchronization signals and a PBCH, wherein a set of resources for transmission of a SIB1 is based at least in part on one or more RBs associated with the SSB, an SSB transmission pattern, and information transmitted via the PBCH, and transmitting the SIB1 via the set of resources.

In some implementations of the NE and method described herein, the NE and method may further be configured to, capable of, performed, performable, or operable to receive a RACH message associated with the SSB.

In some implementations of the NE and method described herein, the information transmitted via the PBCH indicates at least two RB offsets, wherein a first RB offset of the at least two RB offsets spans between a first RB of the SSB to a first RB of the SIB1, and wherein a second RB offset of the at least two RB offsets spans between an end RB of the SIB1 to a first RB of CORESET0.

In some implementations of the NE and method described herein, the information transmitted via the PBCH indicates whether to skip resources associated with a CORESET0 for reception of the SIB1.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit an SSB that contains synchronization signals and a PBCH, wherein the information provided by the PBCH indicates two RB offsets, including: a first RB offset spanning between a first RB of the SSB to a first RB of frequency resources assigned to the SIB1; and a second RB offset spanning between an end RB of the frequency resources assigned to the SIB1 to a first RB of frequency resources assigned to a CORESET0, and receive, from a UE, a RACH message associated with the SSB.

A method performed or performable by the network entity is described. The method may comprise transmitting an SSB that contains synchronization signals and a PBCH, wherein the information provided by the PBCH indicates two RB offsets, including: a first RB offset spanning between a first RB of the SSB to a first RB of frequency resources assigned to the SIB1, and a second RB offset spanning between an end RB of the frequency resources assigned to the SIB1 to a first RB of frequency resources assigned to a CORESET0, and receiving, from a UE, a RACH message associated with the SSB.

In some implementations of the network entity and method described herein, the information provided by the PBCH indicates, to the UE, whether physical downlink control channel (PDCCH) monitoring occasions of the SSB and associated with the CORESET0 are to be skipped for reception of the SIB1 message.

### BRIEF DESCRIPTION OF THE DRAWINGS

FIG. 1 illustrates an example of a wireless communications system in accordance with aspects of the present disclosure.

FIG. 2 illustrates an example signaling between an NE and a UE in accordance with aspects of the present disclosure.

FIG. 3A illustrates another example signaling between an NE and a UE in accordance with aspects of the present disclosure.

FIG. 3B illustrates an example PBCH configuration in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

FIG. 9 illustrates a flowchart of a method performed by an NE in accordance with aspects of the present disclosure.

### DETAILED DESCRIPTION

A wireless communications system may support various communication frameworks for signaling different device types (also referred to as categories), including LPWA devices and non-LPWA devices. Signaling, such as downlink synchronization signals, may differ for various device types. By way of example, the transmission of SIB1 may differ between LPWA devices and non-LPWA devices due to variations in SIB1 content and/or transmission characteristics of SIB1. To enhance SIB1 coverage for LPWA devices, transmission of SIB1 may be repeated multiple times over a duration (e.g., an extended time window) and may include content that is not relevant to non-LPWA devices. Additionally, SIB1 for non-LPWA devices may contain information that is inapplicable or unnecessary for LPWA devices. That is, scheduling information for SIB2 and other SIBs may be included in SIB1-BR for LPWA devices, whereas scheduling information included in SIB1 for non-LPWA devices may be different for the non-LPWA devices.

For LPWA devices, SIB1, or SIB1-BR, may be transmitted over a shared channel, such as a physical downlink shared channel (PDSCH), using predetermined resources and one or more transmission characteristics. These characteristics may include a number of repetitions, specific transmission and reception beams, and transmission configuration indicator (TCI) states, and so on. However, for non-LWPA devices, SIB1 is dynamically scheduled on the PDSCH, with scheduled resources determined by downlink control information (DCI) within a CORESET0. For LPWA devices, reliance on predetermined resources limits flexibility, potentially leading to suboptimal resource utilization. Additionally, the requirement for multiple repetitions of SIB1-BR to ensure coverage significantly increases overhead. Further, for non-LPWA devices, dynamic scheduling of SIB1 via CORESET0 might increase the complexity of control signaling, potentially leading to increased power consumption and processing burdens for the non-LPWA devices.

Various aspects of the present disclosure relate to resource allocation for transmission of SIB1 in wireless communication systems deploying both LPWA (e.g., IoT devices) and non-LPWA devices. A network entity, such as a base station or the like may support a single downlink synchronization signal (SS) for multiple types of devices (e.g., LPWA devices and non-LPWA devices). The network entity may support transmission of SIB1-BR for LPWA devices by utilizing pre-determined resources based on aspects of a transmission of an SSB, such as RBs allocated for the transmission, an SSB index, a beam associated with the transmission, and so on. Additionally, the network entity may utilize a CORESET0 configuration for non-LWPA devices to ensure efficient resource utilization across different device types.

By relying on pre-determined resources rather than dynamically scheduled resources for transmission and repetitions of SIB1-BR, one or more of the network entity and the LPWA devices may reduce or eliminate the PDCCH scheduling overhead associated with each transmission and/or repetition of SIB1-BR. This is particularly beneficial for LPWA devices, where the number of repetitions can be substantial (e.g., hundreds of repetitions) to ensure adequate coverage. While predetermined resource allocation may reduce scheduling flexibility compared to dynamic resource allocation, it provides a more efficient mechanism for handling high-repetition transmissions while minimizing control signaling overhead. Further, aspects of the present disclosure may mitigate or prevent conflicts (e.g., overlap) in monitoring occasions between LPW devices and non-LPWA devices. For example, decoupling SIB1-BR resource allocation from PDCCH-based scheduling reduces the likelihood of overlapping monitoring occasions, such as those associated with CORESET0-based SIB1 scheduling for non-LWPA devices and SIB1-BR for LWPA devices. Thus, this approach minimizes contention for shared resources, and ensures more reliable system information delivery to both LPWA and non-LPWA devices.

Aspects of the present disclosure are described in the context of a wireless communications system.

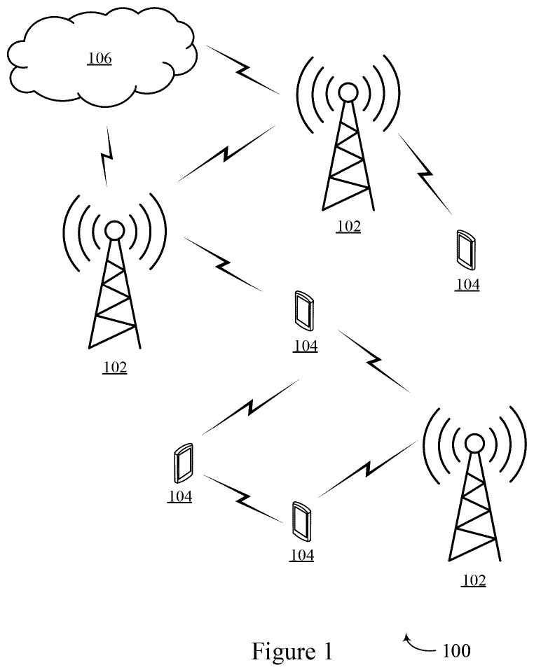

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHZ-114.25 GHZ), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may introduce mechanisms and/or procedures for allocating resources associated with transmitting system information to devices of different types, such as to LPWA and non-LPWA devices. After a UE (e.g., an LPWA UE) has acquired synchronization with a base station (e.g., has decoded the PBCH), the UE may determine resources (e.g., time and/or frequency resources and communication beams/TCI states for DL transmissions) of a SIB1-BR based on a master information block (MIB), frame number, subframe number, system bandwidth (BW), number of repetitions, and SSB time and/or frequency resources, SSB burst time, frequency resources and/or a set of SSB beams/TCI states, a CORESET0, and/or search spaces associated with the CORESET0.

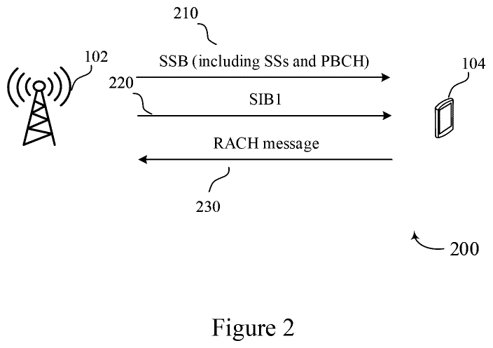

FIG. 2 illustrates an example signaling 200 between the NE 102 and the UE 104 in accordance with aspects of the present disclosure. The UE 104 accesses an SSB 210 transmitted by the NE 102 (e.g., a base station). Using information with the SSB 210, such as the MIB, SSB time and/or frequency resources, the CORESET0, and so on, the UE 104 determines a set of resources (e.g., time and/or frequency resources) and receives an SIB1 via the determined set of resources. The UE 104 may then perform a RACH procedure 230 via information contained in the received SIB1 220 (e.g., the SIB1 being a SIB1-BR).

In some embodiments, the UE 104 may determine a set of frequency resources for the transmission of the SIB1-BR from a set of possible frequency resources (e.g., narrowbands), where the UE 104 cycles through possible narrowbands with a set of slots (e.g., as a function of a cell ID and/or system BW). For example, the UE 104 may utilize a formula to determine the cycling order. The UE 104 may also cycle through a set of beams/TCI states (e.g., determined based on the detected SSB) according to the formula or other techniques.

In some cases, the BW of a subband may be pre-determined. For example, the BW may be 6, 8, or 12 physical resource blocks (PRBs), may be equal to or a function (e.g., multiple of) a number of PRBs for the SSBs, a primary synchronization signal (PSS), a secondary synchronization signals (SSS), the PBCH, and so on, and/or a fraction (e.g., indicated by the MIB/PBCH) of the SSBs, the PSS, the SSS, the PBCH, and so on. In some cases, the BW of a subband may be indicated by the MIB and/or PBCH (e.g., the BW of each subband is determined and/or based on a value indicated by the MIB pointing to an entry in a pre-defined table.

In some cases, a set of possible narrowbands may be determined from a nominal number of subbands (N). For example, a system BW is equally divided into N subbands, and the set of possible narrowbands are the subbands that do not overlap with SSB subcarriers (SCs). The N subbands may be determined based on a pre-determined table or formula for each system BW/carrier frequency, and/or indicated via the MIB/PBCH.

In some cases, the N subbands may be based on the number of RBs of the CORESET0. For example, N is determined based on the largest multiple of a subband BW (e.g., a narrowband) that is not larger than the number of RBs of CORESET0. As another example, N is determined based on a largest multiple of a subband BW (e.g., a narrowband) that is not larger than the number of RBs of CORESET0 plus/minus an RB offset corresponding to the CORESET0 determined by the MIB/PBCH.

In some cases, a start or end of an SSB (e.g., a first RB or last RB of an SSB) may be a reference for counting the N subbands. For example, before decoding the SIB1, the UE 104 may not have knowledge of a common RB0 or pointA (e.g., as defined in 3GPP specifications), and the starting RB and/or ending RB may act as a known RB for counting or determining the number N of subbands.

The offset (e.g., an RB offset) may be indicated by the MIB/PBCH and/or may be the same as (or a function of) an RB offset determined for the CORESET0. For example, the RB offset may be defined from a start or end of the CORESET0 and may be based on a size of a narrowband and/or a subband. In some cases, the set of slots associated with SIB1-BR transmissions/receptions is determined based on a number of SIB1 repetitions (e.g., M repetitions), where the M repetitions are based on the MIB.

In some embodiments, the UE 104 may determine a set of time resources for the transmission of the SIB1-BR based on a number of repetitions and a periodicity. For example, for 4 (re)-transmissions/repetitions, transmissions occur in subframe #4 of every other radio frame (e.g., a cell-ID determines odd/even radio frames to be used). As another example, for 8 (re)-transmissions/repetitions, transmissions occur in subframe #4 or #9 of every radio frame (e.g., the cell-ID determines subframe number to be used). As another example, for 16 (re)-transmissions/repetitions, transmissions occur in subframes #(4,9) or #(0,9) of every radio frame (e.g., the cell-ID determines the subframe pair to be used).

In some cases, the set of slots in each radio frame is determined for SIB1-BR transmissions/repetitions. For example, the set of slots may be determined according to a cell-ID, a number of repetitions, and/or SSB time resources (e.g., a half-frame). In some cases, the set of slots may be determined based on a search space periodicity of the CORESET0 (e.g., to avoid overlap with the CORESET0 resources).

In 5G, SSB bursts may be mapped within a half-frame for a 15 KHz SCS (subcarrier spacing). For example, for f_{c}≤3 GHz: the SSB bursts are mapped to the first and the second slots of a half frame of a radio frame, and for 3 GHz<f_{c}≤6 GHZ, the SSB bursts are mapped to the first four slots of a half frame of a radio frame. In some cases, the SSB periodicity and the SSB position in the SSB burst may be indicated in the SIB1 message (e.g., the UE 104 may not have knowledge before decoding the SIB1-BR).

However, in some cases, a half-frame bit is indicated by the PBCH. For example, the bit is set to “0” if/when the SSB is transmitted in the first half-frame of a 10 ms frame or set to “1” if/when the SSB is transmitted in the second half-frame of the 10 ms frame. Thus, the set of SIB1-BR slots may be determined based on to the cell-ID and/or a number of repetitions, based on the half-frame index.

In some cases, the SIB1-BR slots are not mapped and/or do not include half-frames associated with SSBs. The SIB1-BR may not be mapped to half-frames associated with SSBs or to different set of slots (e.g., a subset of slots) in the half-frame that is associated with the detected SSB. For example, when the SSB is detected in the first half-frame of a radio frame, the slots in the first half-frame for SIB1-BR transmissions/receptions are {2,3,4}, while in the second half-frame the slots are {0,1,2,3,4}.

As another example (depicted in the following Tables), the UE 104 may receive the SIB1-BR based on a detected half-frame. Table 1 depicts a set of frames and slots for SIB1-BR for N_{RB}^{DL}>15, f_{c}≤3 GHZ (e.g., the SSB detected in 1^{st} half-frame):

TABLE 1

| | | Frame structure | | Frame structure | |
|---|---|---|---|---|---|
| | | type 1 | | type 2 | |
| N_{PDSCH}^{SIB1-BR} | N_{ID}^{cell} mod 2 | n_{f} mod 2 | n_{slf} | n_{f} mod 2 | n_{slf} |
| 4 | 0 | 0 | 4 | 1 | 5 |
| | 1 | 1 | 4 | 1 | 0 |
| 8 | 0 | 0, 1 | 4 | 0, 1 | 5 |
| | 1 | 0, 1 | 9 | 0, 1 | 0 |
| 16 | 0 | 0, 1 | 4, 9 | 0, 1 | 0, 5 |
| | 1 | 0, 1 | 2, 9 | 0, 1 | 0, 5 |
| 32 | 0 | 0, 1 | 2, 3, 4, 5 | TBD | TBD |
| | 1 | 0, 1 | 6, 7, 8, 9 | TBD | TBD |

Table 2 depicts a set of frames and slots for SIB1-BR for N_{RB}^{DL}>15, f_{c}≤3 GHZ (e.g., the SSB detected in 2^{nd} half-frame):

TABLE 2

| | | Frame structure | | Frame structure | |
|---|---|---|---|---|---|
| | | type 1 | | type 2 | |
| N_{PDSCH}^{SIB1-BR} | N_{ID}^{cell} mod 2 | n_{f} mod 2 | n_{slf} | n_{f} mod 2 | n_{slf} |
| 4 | 0 | 0 | 4 | 1 | 5 |
| | 1 | 1 | 4 | 1 | 0 |
| 8 | 0 | 0, 1 | 4 | 0, 1 | 5 |
| | 1 | 0, 1 | 9 | 0, 1 | 0 |
| 16 | 0 | 0, 1 | 4, 9 | 0, 1 | 0, 5 |
| | 1 | 0, 1 | 2, 9 | 0, 1 | 0, 5 |
| 32 | 0 | 0, 1 | 0, 1, 2, 3 | TBD | TBD |
| | 1 | 0, 1 | 4, 7, 8, 9 | TBD | TBD |

In some cases, the time resources for SIB1-BR may be determined from a pre-configured/pre-determined table based on the carrier frequency and/or a default SSB periodicity (e.g., 5 ms or 20 ms), because the actual SSB periodicity may not be known prior to decoding the SIB1-BR/SIB1. The default SSB periodicity may be predetermined/pre-configured or indicated in the MIB. For carrier frequencies smaller than a first threshold (e.g., 3 GHZ), there is a first mapping of SIB1-BR to slots of one or two radio frames, and for carrier frequencies larger than the first threshold and smaller than the second threshold, there is a second mapping of SIB1-BR to slots of one or two radio frames. Further, carrier frequencies smaller than the first threshold may support a greater number of repetitions per one or two radio frames.

The following tables correspond to a default SSB periodicity of 10 ms (e.g., for 8 or more SIB1-BR transmissions). For example, Table 3 depicts a set of frames and slots for SIB1-BR for N_{RB}^{DL}>15, f_{c}≤3 GHz,b where (n_{f} mod 2=0 corresponds to the radio frame in which the SSB is detected):

TABLE 3

| | | Frame structure | | Frame structure | |
|---|---|---|---|---|---|
| | | type 1 | | type 2 | |
| N_{PDSCH}^{SIB1-BR} | N_{ID}^{cell} mod 2 | n_{f} mod 2 | n_{slf} | n_{f} mod 2 | n_{slf} |
| 4 | 0 | 0 | 4 | 1 | 5 |
| | 1 | 1 | 4 | 1 | 0 |
| 8 | 0 | 0, 1 | 4 | 0, 1 | 5 |
| | 1 | 0, 1 | 9 | 0, 1 | 0 |
| 16 | 0 | 0, 1 | 4, 9 | 0, 1 | 0, 5 |
| | 1 | 0, 1 | 2, 9 | 0, 1 | 0, 5 |
| 32 | 0 | 0, 1 | 2, 3, 8, 9 | TBD | TBD |
| | 1 | 0, 1 | 2, 4, 7, 9 | TBD | TBD |

As another example, Table 4 depicts a set of frames and slots for SIB1-BR for N_{RB}^{DL}>15, 3<f_{c}≤6 GHZ:

TABLE 4

| | | Frame structure | | Frame structure | |
|---|---|---|---|---|---|
| | | type 1 | | type 2 | |
| N_{PDSCH}^{SIB1-BR} | N_{ID}^{cell} mod 2 | n_{f} mod 2 | n_{slf} | n_{f} mod 2 | n_{slf} |
| 4 | 0 | 0 | 4 | 1 | 5 |
| | 1 | 1 | 4 | 1 | 0 |
| 8 | 0 | 0, 1 | 4 | 0, 1 | 5 |
| | 1 | 0, 1 | 9 | 0, 1 | 0 |
| 16 | 0 | 0, 1 | 4, 9 | 0, 1 | 0, 5 |
| | 1 | 0, 1 | 0, 9 | 0, 1 | 0, 5 |

The following table corresponds to a 20 ms default SSB periodicity. For example, Table 5 depicts a set of frames and slots for SIB1-BR for N_{RB}^{DL}>15, f_{c}≤3 GHZ, given a default SSB periodicity=20 ms:

TABLE 5

| | N_{ID}^{cell} | Frame structure type 1 | | Frame structure type 2 | |
|---|---|---|---|---|---|
| N_{PDSCH}^{SIB1-BR} | mod 2 | n_{f} mod 2 | n_{slf} | n_{f} mod 2 | n_{slf} |
| 4 | 0 | 0 | 4 | 1 | 5 |
| | 1 | 1 | 4 | 1 | 0 |
| 8 | 0 | 0, 1 | 4 | 0, 1 | 5 |
| | 1 | 0, 1 | 9 | 0, 1 | 0 |
| 16 | 0 | 0, 1 | 4, 9 | 0, 1 | 0, 5 |
| | 1 | 0, 1 | 2, 9 | 0, 1 | 0, 5 |
| 32 | 0 | 0, 1 | 2, 3, 8, 9 | TBD | TBD |
| | 1 | 0, 1 | 2, 4, 7, 9 | TBD | TBD |
| 64 | 0 | 0 | 2, 3, 4, 5, | TBD | TBD |
| | | | 6, 7, 8, 9 | | |
| | | 1 | 0, 1, 4, 5, | | |
| | | | 6, 7, 8, 9 | | |
| | 1 | 0 | 0, 1, 4, 5, | TBD | TBD |
| | | | 6, 7, 8, 9 | | |
| | | 1 | 2, 3, 4, 5, | | |
| | | | 6, 7, 8, 9 | | |

In some cases, the SIB1-BR frequency resources may be determined based on an offset (e.g., a unit of pre-determined value, such as an RB) with respect to a start or end of the CORESET0 frequency resources and/or a lowest SSB frequency resource. In some cases, the SIB1-BR time resources may be determined based on an offset (e.g., a slot or sub-frame) with respect to a start or end of a search space set associated with the CORESET0.

In some cases, the determined SIB1-BR resources/occasions may overlap with resources of search space sets associated with the CORESET0 for non-LPWA devices. The non-LPWA devices may not monitor PDCCH candidates in the overlapping monitoring occasions and/or may ignore/skip SIB1-BR occasions that overlap with resources of search space sets associated with the CORESET0. In some cases, the MIB/PBCH/SSB instructs the non-LPWA devices whether to skip monitoring PDCCH occasions of CORESET0 that overlap with SIB1-BR transmissions. Further, the SIB1-BR occasions may be shifted in time or in frequency, where the shift is based on the CORESET0 size/duration and/or the search space set associated with the CORESET0.

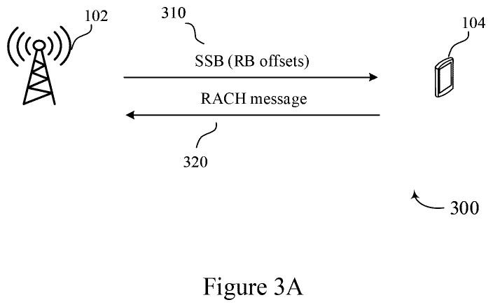

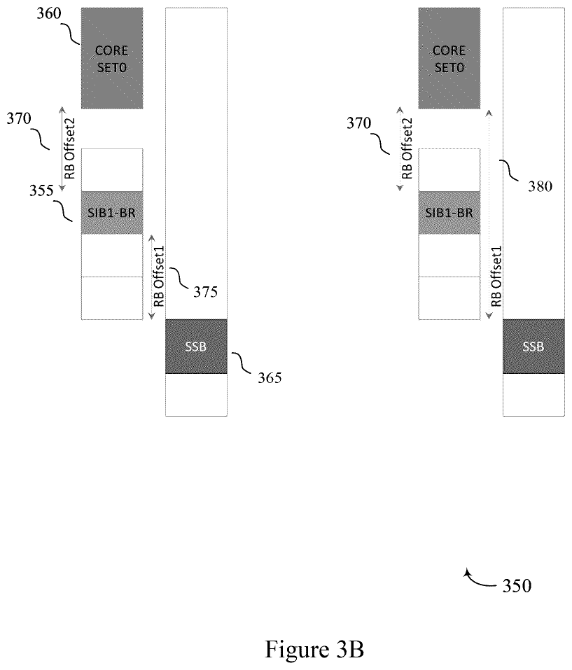

In some embodiments, the CORESET0 and/or an associated search space set may be determined in order to avoid overlap with SIB1-BR resources. FIG. 3A illustrates an example signaling 300 between an NE and a UE in accordance with aspects of the present disclosure. The NE 102 may transmit an SSB 310 that indicates the RB offsets applicable to or associated with the SIB1-BR. The UE 104 (e.g., an LPWA UE) receives the SIB1-BR via the SSB 310 and performs a RACH procedure 320 via information contained in the received SIB1-BR.

For example, a MIB may indicate a first RB offset (e.g., from a starting/ending RB of the SSB 310) for the SIB1-BR and a second RB offset (e.g., with respect to the SIB1-BR or the starting/ending RB of the SSB 310) for the CORESET0. The second RB offset may be identified with respect to a beginning/end of a narrowband corresponding to the first RB offset.

In some cases, based on cycling over different narrowbands for SIB1-BR transmission, the first RB offset may be associated with a reference time (e.g., mod (radio frame, A)=0, where “A” is fixed or determined based on the number of possible narrowbands/repetitions).

FIG. 3B illustrates an example PBCH configuration 350 in accordance with aspects of the present disclosure. As shown, a SIB1-BR 355 is defined based on two offsets, a first RB offset 370 that spans the SIB1-BR 355 to a CORESET0 360, and a second RB offset 375 that spans the SIB1-BR 355 to a beginning of an SSB 365. The SIB1-BR 355 may also be indicated via an RB offset 380 with respect to the start or end of the CORESET0.

In some cases, a narrowband index does not change when a CORESET0 is provided in the PBCH. However, when a change of the narrowband index for SIB1-BR in different SIB1-BR transmissions (e.g., the SIB1-BR is transmitted in different narrowbands according to a cyclic operation) is supported, the NE 102 may implement the following mechanisms.

In some cases, the CORESET0 frequency resources may be updated in each cyclic change of narrowbands (e.g., to maintain an offset between CORESET0 and SIB1-BR or at least to not have any overlap between the two). In some cases, the cyclic change of narrowbands may occur with narrowbands that do not collide with CORESET0 frequency resources.

In some cases, the set of narrowbands, which can be cyclically used for SIB1-BR transmissions, may be updated at each time instance, such as in a first time instance, which overlaps with a PDCCH monitoring occasion of CORESET0, an LPWA device has a first set of possible narrowbands to cycle through, and/or in a second time instance, which does not overlap with any PDCCH monitoring occasion of CORESET0, the LPWA device utilizes a second set of possible narrowbands to cycle through. The first set of possible narrowbands may not have overlapping RBs with CORESET0, whereas the second set of narrowbands may overlap with the CORESET0. Such schemes may provide for CORESET0 frequency resources not changing from one time instance to another time instance as the narrowbands are cycled through for a SIB1-BR transmission.

Thus, the systems and methods described herein may avoid the overlap of monitoring occasions (e.g., PDCCH monitoring occasions) associated with use of the CORESET0 for non-LPWA devices with SIB1-BR receptions of LPWA devices, among other benefits.

In some cases, a UE determines a TCI state for a PDSCH carrying SIB1-BR in a slot based on a formula/lookup table using a radio frame/half-frame/slot as an input. For example, a PDSCH transmission carrying SIB1-BR in a first slot of a half-frame that does not include any SSB transmission is associated with a first TCI state of a set of TCI states, and a PDSCH transmission carrying SIB1-BR in a second slot of the half-frame is associated with a second TCI state of the set of TCI states. The set of TCI states can be determined based on the detected SSB. For example, the PBCH/MIB of the SSB indicates the set or a parameter from which the set of TCI states can be determined.

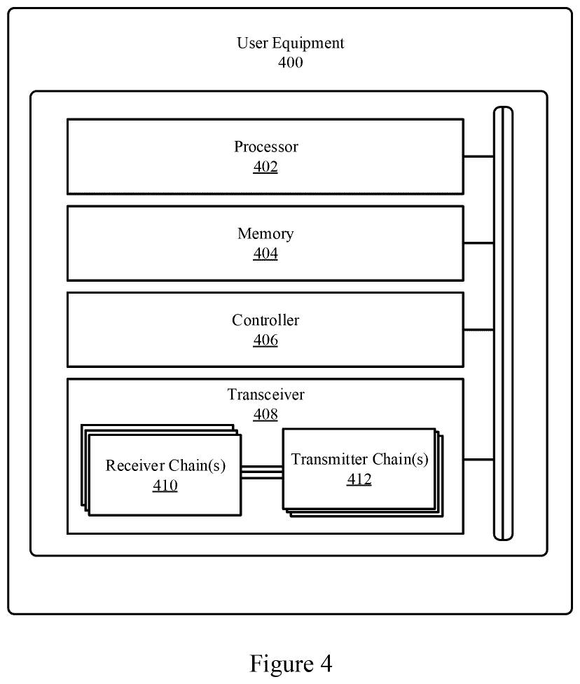

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving an SSB that includes one or more synchronization signals and a PBCH, determining a set of resources for reception of a SIB1 based at least in part on one or more resource blocks (RBs) associated with the SSB, an SSB transmission pattern, and information received via the PBCH, and receiving the SIB1 via the determined set of resources.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

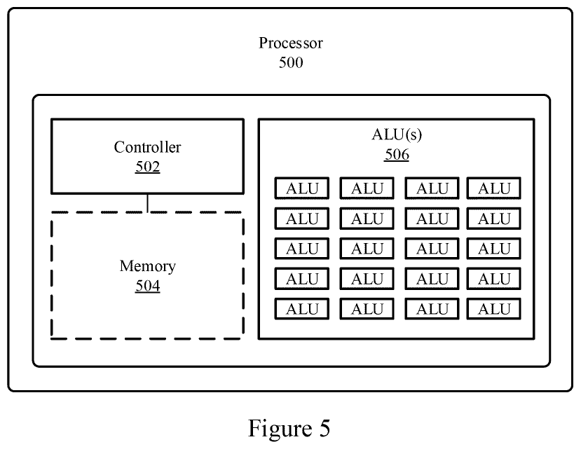

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. For example, the processor 500 may be configured to support a means for receiving an SSB that includes one or more synchronization signals and a PBCH, determining a set of resources for reception of a SIB1 based at least in part on one or more resource blocks (RBs) associated with the SSB, an SSB transmission pattern, and information received via the PBCH, and receiving the SIB1 via the determined set of resources.

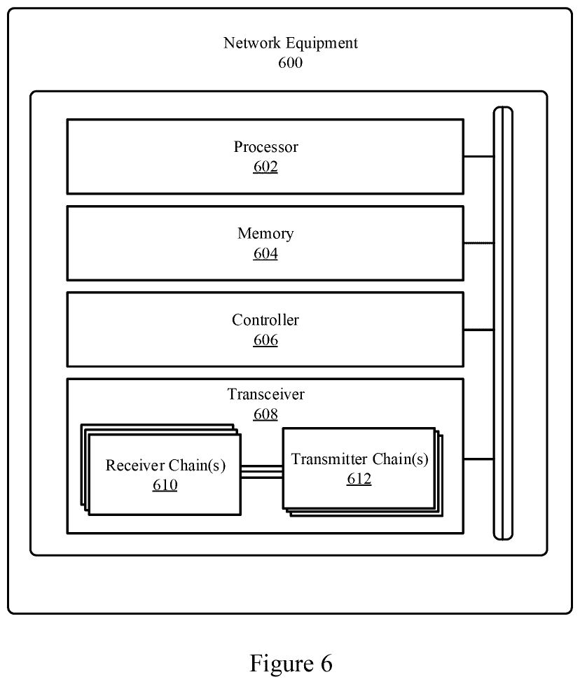

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for transmitting an SSB that contains synchronization signals and a PBCH, wherein the information provided by the PBCH indicates two RB offsets, including a first RB offset spanning between a first RB of the SSB to a first RB of frequency resources assigned to the SIB1 and a second RB offset spanning between an end RB of the frequency resources assigned to the SIB1 to a first RB of frequency resources assigned to CORESET0, and receiving, from a UE, a RACH message associated with the SSB.

As another example, the NE 600 may be configured to support a means for transmitting an SSB that includes one or more synchronization signals and a PBCH, wherein a set of resources for transmission of an SIB1 is based at least in part on one or more RBs associated with the SSB, an SSB transmission pattern, and information transmitted via the PBCH, and transmitting the SIB1 via the set of resources.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

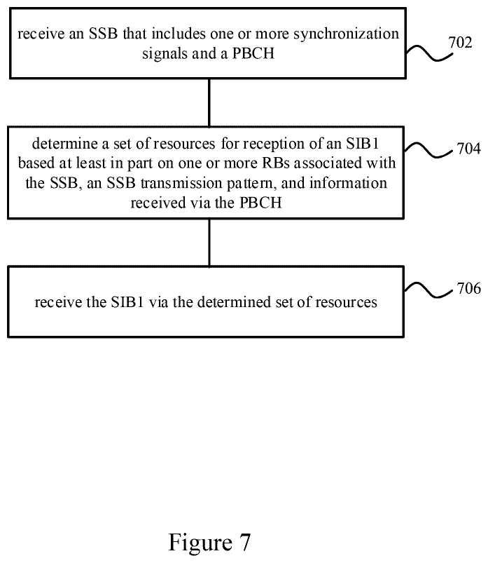

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include receiving an SSB that includes one or more synchronization signals and a PBCH. The operations of 702 may be performed in accordance with examples as described herein. In some implementations, aspects of the operations of 702 may be performed by a UE described with reference to FIG. 4.

At 704, the method may include determining a set of resources for reception of a SIB1 based at least in part on one or more resource blocks (RBs) associated with the SSB, an SSB transmission pattern, and information received via the PBCH. The operations of 704 may be performed in accordance with examples as described herein. In some implementations, aspects of the operations of 704 may be performed by a UE as described with reference to FIG. 4.

At 706, the method may include receiving the SIB1 via the determined set of resources. The operations of 706 may be performed in accordance with examples as described herein. In some implementations, aspects of the operations of 706 may be performed by a UE as described with reference to FIG. 4.

It should be noted that the method described herein describes a possible implementation, and that the operations and the steps may be rearranged or otherwise modified and that other implementations are possible.

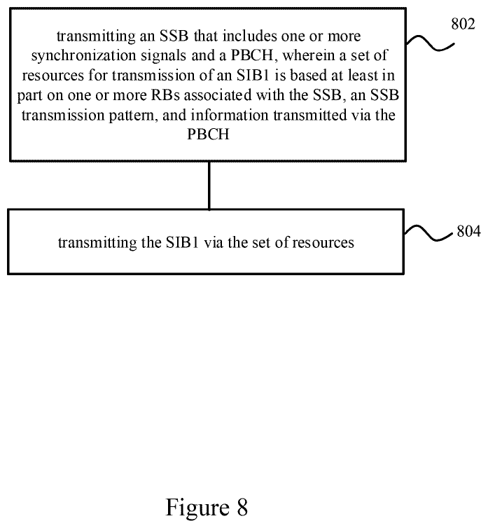

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include transmitting an SSB that includes one or more synchronization signals and a PBCH, wherein a set of resources for transmission of an SIB1 is based at least in part on one or more RBs associated with the SSB, an SSB transmission pattern, and information transmitted via the PBCH. The operations of 802 may be performed in accordance with examples as described herein. In some implementations, aspects of the operations of 802 may be performed by an NE as described with reference to FIG. 6.

At 804, the method may include transmitting the SIB1 via the set of resources. The operations of 804 may be performed in accordance with examples as described herein. In some implementations, aspects of the operations of 804 may be performed by an NE as described with reference to FIG. 6.

It should be noted that the method described herein describes a possible implementation, and that the operations and the steps may be rearranged or otherwise modified and that other implementations are possible.

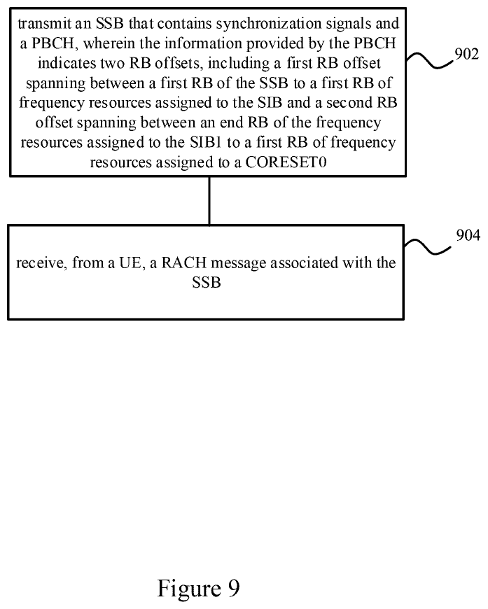

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include transmitting an SSB that contains synchronization signals and a PBCH, wherein the information provided by the PBCH indicates two RB offsets, including a first RB offset spanning between a first RB of the SSB to a first RB of frequency resources assigned to the SIB1 and a second RB offset spanning between an end RB of the frequency resources assigned to the SIB1 to a first RB of frequency resources assigned to CORESET0. The operations of 902 may be performed in accordance with examples as described herein. In some implementations, aspects of the operations of 902 may be performed by an NE as described with reference to FIG. 6.

At 904, the method may include receiving, from a UE, a RACH message associated with the SSB. The operations of 904 may be performed in accordance with examples as described herein. In some implementations, aspects of the operations of 904 may be performed by an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a synchronization signal block (SSB) that includes one or more synchronization signals and a physical broadcast channel (PBCH);
determine a set of resources for reception of a system information block type 1 (SIB1) based at least in part on one or more resource blocks (RBs) associated with the SSB, an SSB transmission pattern, and information received via the PBCH; and
receive the SIB1 via the determined set of resources.

2. The UE of claim 1, wherein, in response to the SIB1 being a SIB1 bandwidth reduced (SIB1-BR), the at least one processor is configured to cause the UE to:
determine the set of resources based at least in part on a candidate set of resources,
wherein the candidate set of resources comprises a set of frequency resources comprising one or more narrowbands, and
wherein an indexing of the one or more narrowbands is according to a start of the SSB or an end of the SSB, or an offset based on the start of the SSB or the end of the SSB.

3. The UE of claim 2, wherein the at least one processor is configured to cause the UE to:
identify a number of narrowbands based at least in part on the information received via the PBCH,
wherein the set of resources is determined based at least in part on the identified number of narrowbands.

4. The UE of claim 3, wherein the number of narrowbands is further based at least in part on a number of RBs of each narrowband and a number of RBs of a control resource set zero (CORESET0).

5. The UE of claim 2, wherein the indexing of the one or more narrowbands is further according to a distance in a frequency domain between each narrowband and a first RB or a last RB of the SSB.

6. The UE of claim 1, wherein the set of resources comprises a set of time resources, and wherein the at least one processor is configured to cause the UE to:
determine the set of time resources based at least in part on one or more of: a cell identifier associated with transmission of the SSB, a number of repetitions of SIB1, a portion of a frame associated with transmission of the SSB, or a SSB transmission pattern associated with a carrier frequency.

7. The UE of claim 6, wherein a number of repetitions of SIB1 during a first portion of a radio frame is less than a number of repetitions of SIB1 during a second portion of the radio frame, and wherein the first portion of the radio frame is associated with transmission of the SSB.

8. The UE of claim 1, wherein the set of resources comprises a set of time resources, and wherein the at least one processor is configured to cause the UE to:
determine the set of time resources based at least in part on a portion of a frame associated with transmission of the SSB or a SSB transmission pattern associated with a carrier frequency when a number of repetitions of SIB1 is greater than a threshold.

9. The UE of claim 1, wherein the information received via the PBCH indicates at least two RB offsets, wherein a first RB offset of the at least two RB offsets spans between a first RB of the SSB to a first RB of the SIB1, and wherein a second RB offset of the at least two RB offsets spans between an end RB of the SIB1 to a first RB of a control resource set zero (CORESET0).

10. The UE of claim 1, wherein the information received via the PBCH indicates whether to skip resources associated with a control resource set zero (CORESET0) for reception of the SIB1.

11. The UE of claim 1, wherein the at least one processor is configured to cause the UE to:
transmit a random access channel (RACH) message associated with the SSB.

12. A network entity for wireless communication, comprising:
at least one memory; and
at least one processor coupled with the at least one memory and configured to cause the network entity to:
transmit a synchronization signal block (SSB) that includes one or more synchronization signals and a physical broadcast channel (PBCH),
wherein a set of resources for transmission of a system information block type 1 (SIB1) is based at least in part on one or more resource blocks (RBs) associated with the SSB, an SSB transmission pattern, and information transmitted via the PBCH; and
transmit the SIB1 via the set of resources.

13. The network entity of claim 12, wherein the at least one processor is further configured to cause the network entity to receive a random access channel (RACH) message associated with the SSB.

14. The network entity of claim 12, wherein the information transmitted via the PBCH indicates at least two RB offsets, wherein a first RB offset of the at least two RB offsets spans between a first RB of the SSB to a first RB of the SIB1, and wherein a second RB offset of the at least two RB offsets spans between an end RB of the SIB1 to a first RB of a control resource set zero (CORESET0).

15. The network entity of claim 12, wherein the information transmitted via the PBCH indicates whether to skip resources associated with a control resource set zero (CORESET0) for reception of the SIB1.

16. A method performed by a user equipment (UE), the method comprising:
receiving a synchronization signal block (SSB) that includes one or more synchronization signals and a physical broadcast channel (PBCH);
determining a set of resources for reception of a system information block type 1 (SIB1) based at least in part on one or more resource blocks (RBs) associated with the SSB, information received via the PBCH, and a carrier frequency; and
receiving the SIB1 via the determined set of resources.

17. The method of claim 15, wherein the SIB1 is a SIB1 bandwidth reduced (SIB1-BR), the method further comprising:
determining the set of resources based at least in part on a set of candidate resources,
wherein the candidate set of resources comprises a set of frequency resources comprising one or more narrowbands, and
wherein an indexing of the one or more narrowbands is according to a start of the SSB or an end of the SSB, or an offset based on the start of the SSB or the end of the SSB.

18. The method of claim 15, further comprising:
identifying a number of narrowbands based at least in part on the information received via the PBCH,
wherein the set of resources is determined based at least in part on the identified number of narrowbands.

19. The method of claim 18, wherein the number of narrowbands is further based at least in part on a number of RBs of each narrowband and a number of RBs of a control resource set zero (CORESET0).

20. A method performed by a network entity, the method comprising:
transmitting a synchronization signal block (SSB) that includes one or more synchronization signals and a physical broadcast channel (PBCH),
wherein a set of resources for transmission of a system information block type 1 (SIB1) is based at least in part on one or more resource blocks (RBs) associated with the SSB, an SSB transmission pattern, and information transmitted via the PBCH; and
transmitting the SIB1 via the set of resources.
